(19) United States
(12) Patent Application Publication
(10) Pub. No.: US 2025/0333151 A1
(43) Pub. Date: Oct. 30, 2025

(54) XR GLASS EQUIPPED UNDERWATER EXPLORATION HELMET AND OPERATING METHOD THEREOF

(71) Applicant: DeepBlueExplorer, Inc., Jeju-si, Jeju-do (KR)

(72) Inventor: Dae Bum KIM, Jeju-si, Jeju-do (KR)

(73) Assignee: DeepBlueExplorer, Inc., Jeju-si, Jeju-do (KR)

(21) Appl. No.: 18/290,576

(22) PCT Filed: Oct. 5, 2023
(86) PCT No.: PCT/KR2023/015289

§ 371 Date: Dec. 4, 2024

(30) Foreign Application Priority Data
Oct. 4, 2023 (KR) 10-2023-0131661

(51) Int. Cl. B63C 11/06; B63C 11/12

(52) U.S. Cl. CPC B63C 11/06; B63C 11/12; B63C 2011/121

(57) ABSTRACT

An XR glasses-equipped underwater exploration helmet and a method of operating the same are disclosed. The XR glasses-equipped underwater exploration helmet includes: an XR execution module creating XR data; an XR display displaying the XR data created by the XR execution module; a GPS module creating GPS location information; and a GPS signal wireless transmission module creating in real time a GPS wireless signal including the GPS location information created in real time by the GPS module, and transmitting the real-time created GPS wireless signal, wherein the XR data are composed of at least one or more of a current water depth, a current underwater temperature, a dive time, and a remaining air volume. According to the XR glasses-equipped underwater exploration helmet and a method of operating the same described above, since an XR glass is mounted on an underwater exploration helmet and is configured to display data such as a remaining air volume of an air tank, a water depth, a water temperature, a dive time, an available dive time, etc., so there is an effect that a diver can conveniently explore without having to frequently check a diving computer or gauges during diving.

### TECHNICAL FIELD

The present disclosure relates to an underwater exploration helmet and a method of operating the underwater exploration helmet and, in more detail, an XR glasses-equipped underwater exploration helmet and a method of operating the XR glasses-equipped underwater exploration helmet.

### BACKGROUND ART

Divers explore with an air tank and a diving computer on in the water.

Divers can visually check a dive time, a water depth, a water temperature, a remaining air volume, etc. through a diving computer worn on the wrist, etc. The remaining air volume of an air tank is transmitted to a diving computer thorough a transmitter and divers manually adjust a regulator to adjust the respiration amount of an oxygen mask in some cases.

As described above, many types of operation of checking and adjusting several items of equipment one by one occur even during exploration in the water. When a large current is generated or a diver loses the balance in this situation, the neutral buoyancy breaks and the diver floats up high in some cases.

Meanwhile, various types of work such as rescue work, underwater structure examination, and underwater structure construction need to be performed in underwater exploration in many cases. There is also a problem that it is difficult to even visually check a diving computer particularly in the water with high turbidity.

It is the situation that there is a need for a means enabling divers to more conveniently check several items of equipment and conveniently and freely work during high-difficulty underwater exploration such as rescue work, underwater structure examination, or underwater structure construction.

### DISCLOSURE

### Technical Problem

An objective of the present disclosure is to provide an XR glasses-equipped underwater exploration helmet.

Another objective of the present disclosure is to provide a method of operating the XR glasses-equipped underwater exploration helmet.

### Technical Solution

An XR glasses-equipped underwater exploration helmet according to an objective of the present disclosure described above may be configured to include: an XR execution module creating XR data; and an XR display displaying the XR data created by the XR execution module.

The XR data may be composed of at least one or more of a current water depth, a current underwater temperature, a dive time, and a remaining air volume.

The XR glasses-equipped underwater exploration helmet may be configured to further include a GPS module creating GPS location information in real time.

The XR glasses-equipped underwater exploration helmet may be configured to further include a GPS signal wireless transmission module creating in real time a GPS wireless signal including the GPS location information created in real time by the GPS module, and transmitting the real-time created GPS wireless signal.

A method of operating an XR glasses-equipped underwater exploration helmet according to anther objective of the present disclosure described above may be configured to include: a step in which an XR execution module creates XR data; and a step in which an XR display displays the XR data created by the XR execution module.

The XR data may be composed of at least one or more of a current water depth, a current underwater temperature, a dive time, and a remaining air volume.

### Advantageous Effects

According to the XR glasses-equipped underwater exploration helmet and a method of operating the same described above, since an XR glass is mounted on an underwater exploration helmet and is configured to display data such as a remaining air volume of an air tank, a water depth, a water temperature, a dive time, an available dive time, etc., so there is an effect that a diver can conveniently explore without having to frequently check a diving computer or gauges during diving.

### DESCRIPTION OF DRAWINGS

FIG. 1 is a block configuration diagram of an XR glasses-equipped underwater exploration helmet according to an embodiment of the present disclosure.

FIG. 2 is a perspective view of the XR glasses-equipped underwater exploration helmet according to an embodiment of the present disclosure.

FIG. 3 is a left side view/right side view of the XR glasses-equipped underwater exploration helmet according to an embodiment of the present disclosure.

FIG. 4 is a front view/rear view of an XR display according to an embodiment of the present disclosure.

FIG. 5 is a flowchart of a method of operating the XR glasses-equipped underwater exploration helmet according to an embodiment of the present disclosure.

### MODE FOR INVENTION

The present disclosure may be modified in various ways and implemented by various exemplary embodiments, so that specific exemplary embodiments are shown in the drawings and will be described in detail in the detailed description for implementing the present disclosure. However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings.

Terms used in the specification, ‘first’, ‘second’, ‘A’, ‘B’, etc., may be used to describe various components, but the components are not to be construed as being limited to the terms. The terms are used only to distinguish one component from another component. For example, the ‘first’ component may be named the ‘second’ component, and vice versa, without departing from the scope of the present invention. The term ‘and/or’ includes a combination of a plurality of relevant items or any one of a plurality of relevant terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only to describe specific exemplary embodiments rather than limiting the present disclosure. Singular forms are intended to include plural forms unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms have the same meaning as those that are understood by those who skilled in the art. It will be further understood that terms defined in dictionaries that are commonly used should be interpreted as having meanings that are consistent with their meanings in the context of the relevant art and will not be interpreted in an idealized or overly formal sense unless expressly so defined herein.

Hereafter, preferred embodiments of the present disclosure are described in detail with reference to the accompanying drawings.

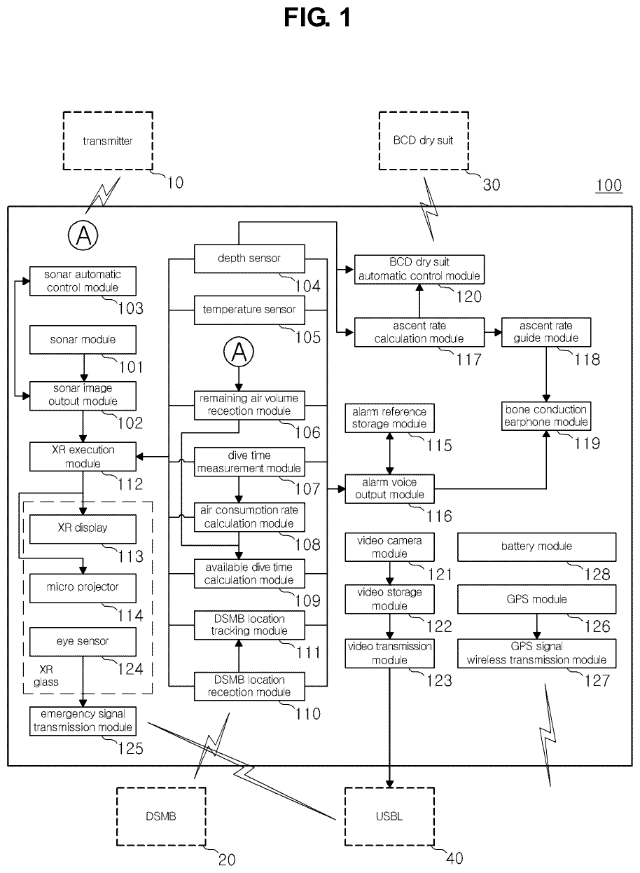

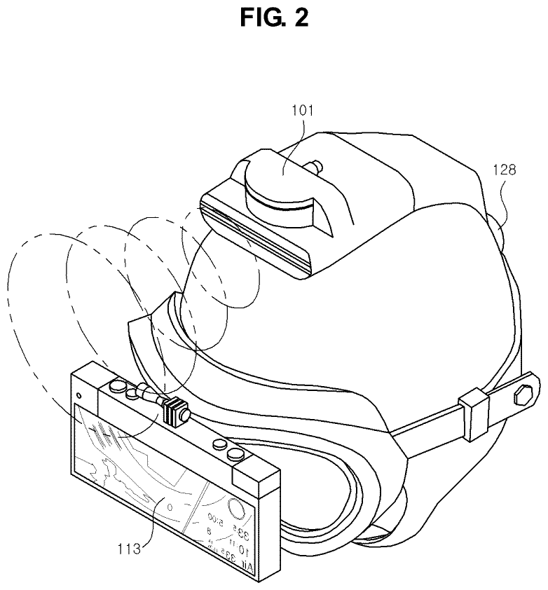

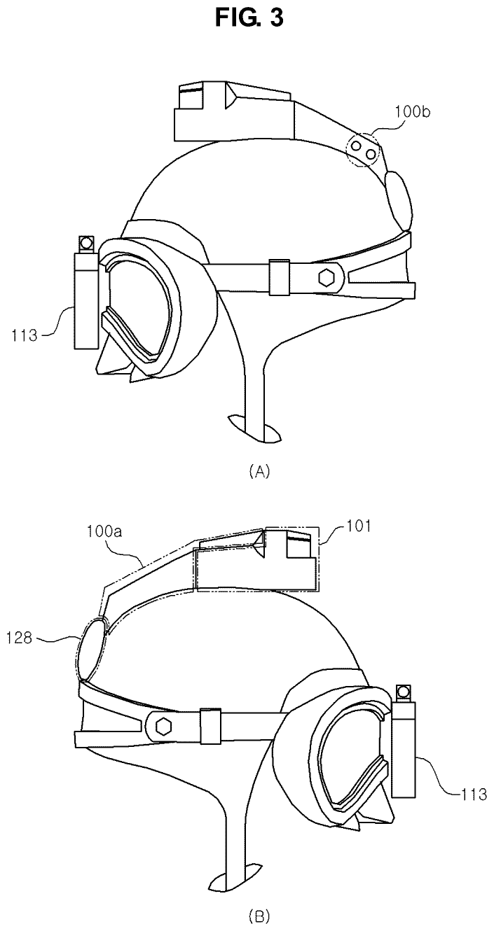

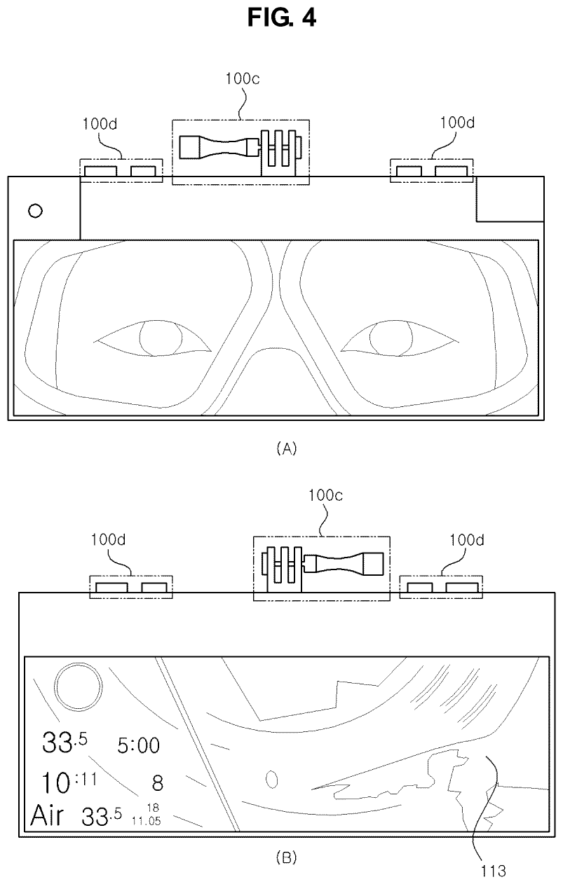

FIG. 1 is a block configuration diagram of an XR glasses-equipped underwater exploration helmet according to an embodiment of the present disclosure. FIG. 2 is a perspective view of the XR glasses-equipped underwater exploration helmet according to an embodiment of the present disclosure, FIG. 3 is a left side view/right side view of the XR glasses-equipped underwater exploration helmet according to an embodiment of the present disclosure, and FIG. 4 is a front view/rear view of an XR display according to an embodiment of the present disclosure.

First, referring to FIG. 1, an XR glasses-equipped underwater exploration helmet 100 according to an embodiment of the present disclosure may include a sonar module 101, a sonar image output module 102, a sonar automatic control module 103, a depth sensor 104, a temperature sensor 105, a remaining air volume reception module 106, a dive time measurement module 107, an air consumption rate calculation module 108, an available dive time calculation module 109, a delayed surface marker buoy (DSMB) location reception module 110, an SMB location tracking module 111, an extended reality (XR) execution module 112, an XR display 113, a micro projector 114, an alarm reference storage module 115, an alarm voice output module 116, an ascent rate calculation module 117, an ascent rate guide module 118, a bone conduction earphone module 119, a buoyancy control device (BCD) dry suit automatic control module 120, a video camera module 121, a video storage module 122, a video transmission module 123, an eye sensor 124, an emergency signal transmission module 125, a GPS module 126, a GPS signal wireless transmission module 127, and a battery module 128.

Hereafter, the detailed description is described.

The sonar module 101 may be configured to detect the surroundings of a user and create a sonar image using sound waves.

The sonar image output module 102 may be configured to output in real time a sonar image created by the sonar module 101.

The sonar automatic control module 103 can control the sonar module 101 to adjust in real time a sound wave emission angle and a sound wave detection distance in accordance with whether a surrounding obstacle is detected through a sonar image.

In general, in the case of the sonar module 10, the definition of a sonar image decreases when the emission angle of a sonar sound wave is large, and the definition of a sonar image increases when the emission angle of a sonar sound wave is small.

The sonar automatic control module 103 can perform control such that whether there is a surrounding obstacle is detected first by increasing the sound wave emission angle when any surrounding obstacle is not detected within a current view angle of a user and such that surrounding obstacles are more closely detected by decreasing the sound wave emission angle when there is a surrounding obstacle.

Meanwhile, it is possible to sense variation of a view angle of a user by a 3D acceleration sensor (not shown) mounted on the XR glasses-equipped underwater exploration helmet 100. In this case, the sonar automatic control module 103 can determine the degree of variation of a view angle of a user, and when it is determined that variation of the view angle is within a predetermined range and there is almost no variation, that is, a user keeps looking at a specific direction over a predetermined time, the sonar automatic control module 103 can increase the definition of a sonar image by decreasing the sound wave emission angle, or when a user changes the view direction while looking around in several directions, the sonar automatic control module 103 can perform control to increase the sound wave emission angle. Accordingly, there is an advantage that a user can conveniently explore even without changing the sound wave emission angle in every case.

The depth sensor 104 may be configured to sense the current water depth.

The temperature sensor 105 may be configured to sense the current underwater temperature.

The remaining air volume reception module 106 may be configured to receive in real time the remaining air volume in an air tank from a transmitter 10. The remaining air volume reception module 106 can receive in real time a remaining air volume using a line, a sound wave, or an ultrasonic wave.

The dive time measurement module 107 may be configured to measure the current dive time in real time. The dive time measurement module 107 can measure a dive time on the basis of the water depth sensed by the depth sensor 104.

The air consumption rate calculation module 108 may be configured to calculate an air consumption rate using the remaining air volume received in real time at the remaining air volume reception module 106 and the current dive time measured in real time by the dive time measurement module 107.

The available dive time calculation module 109 may be configured to calculate an available dive time using the remaining air volume received in real time at the remaining air volume reception module 106 and the air consumption rate calculated in real time by the air consumption rate calculation module 108.

The DSMB location reception module 110 may be configured to receive DSMB location information in real time from a DSMB 20. In this configuration, the DSMB 20 may be equipped with a GPS device (not shown) unlike existing DSMBs so that it is possible to check the current location in real time. The current location of the DSMB 20 may be changed any time by currents and may depart from the initial location.

The DSMB location tracking module 111 may be configured to track the DSMB location in real time using DSMB location information received in real time at the DSMB location reception module 110. A user also can know that he/she departed much from an initial position through the DSMB location tracking module 111.

The XR execution module 112 may be configured to create XR data using a sonar image output in real time from the sonar image output module 102, the current water depth sensed in real time by the depth sensor 104, the current underwater temperature sensed in real time by the temperature sensor 105, the remaining air volume received in real time at the remaining air volume reception module 106, the dive time measured in real time by the dive time measurement module 107, the air consumption rate calculated in real time by the air consumption rate calculation module, the available dive time calculated in real time by the available dive time calculation module, the DSMB location information received at the DSMB location reception module, and the DSMB location tracked in real time by the DSMB location tracking module.

The XR display 113 may be configured to display the XR data created by the XR execution module 112. A user visually checks data, which can be checked through an existing diving computer (not shown) such as a water depth, a water temperature, and a dive time, through the XR display 113, so the user more freely uses both hands and concentrates on underwater exploration work, whereby it is possible to increase efficiency and prevent also safety accidents. Further, the situation in which neutral buoyancy breaks and a user cannot keep his/her location during underwater exploration can be reduced.

In this configuration, the XR display 113, as shown in FIGS. 2 and 3, is attached to the front of the XR glasses-equipped underwater exploration helmet 100 and may be disposed such that a user can visually check it.

Referring to FIG. 4, it can be seen that a user is enabled to visually check underwater areas through the XR display 113 and simultaneously check a sonar image, other diving computer data, or the like on the XR display 113.

Meanwhile, operation buttons 100d are provided to operate the XR display 113.

The micro projector 114 may be configured to output the XR data created by the XR execution module 112 in a beam type to the eyes of a user. Since XR data are directly emitted to eyes, there is the advantage that the definition of XR data increases.

The alarm reference storage module 115 may be configured such that predetermined alarm references are stored in advance. In this case, the alarm references may be configured to prescribe for whether a current water depth, a current underwater temperature, a remaining air volume, a dive time, an air consumption rate, an available dive time, a DSMB location, etc. depart from predetermined reference ranges.

The alarm voice output module 116 may be configured to output in real time respective alarm voices for the current water depth sensed in real time by the depth sensor 104, the current underwater temperature sensed in real time by the temperature sensor 105, the remaining air volume received in real time at the remaining air volume reception module 106, the dive time measured in real time by the dive time measurement module 107, the air consumption rate calculated in real time by the air consumption rate calculation module 108, the available dive time calculated in real time by the available dive time calculation module 109, and the DSMB location tracked in real time by the DSMB location tracking module 111 in accordance with the alarm references stored in advance in the alarm reference storage module 115.

Accordingly, a user can exactly recognize a current dangerous situation.

The ascent rate calculation module 117 may be configured to calculate an ascent rate of a user in real time on the basis of the current water depth sensed in real time by the depth sensor 104. The ascent rate calculation module 119 can calculate the ascent rate of a user by tracking the current water depth in real time.

If a user excessively rapidly ascends when ascending to the surface of the water after finishing diving, nitrogen and hydrogen in the blood boil due to a pressure drop during ascending, thereby producing bubbles. In this case, a use suffers a severe injury to his/her body, and if severe, the use may end up with depth. Accordingly, divers have to very slowly ascend when ascending to the surface of the water and have to stay for a predetermined time on the way of ascending in some cases. However, divers do not appropriately adjust the ascending rate in many cases, and when currents are rapidly generated or divers rapidly float up due to breaking of balance, it is very dangerous.

The ascent rate guide module 118 may be configured to output a guide voice for the ascent rate calculated in real time by the ascent rate calculation module 117. A user can easily know whether the ascent rate is appropriate through the guide voice for the ascent rate.

The bone conduction earphone module 119 may be configured to output the alarm voice output in real time from the alarm voice output module 116 and the guide voice output in real time from the ascent rate guide module 118. When a voice is transmitted in a bone conduction manner, a user can exactly hear voices or sounds even in the water without interference by various noises. Meanwhile, divers should be able to easily sense surrounding sounds in the water in order to prevent safety accidents. Voice transmission of bone conduction manner has another advantage that it is relatively easy to sense sounds that are produced around in the water without missing.

Further, in addition to the bone conduction earphone module 119, an internal speaker module (not shown) may be additionally provided.

The internal speaker module (not shown) may be configured to output the alarm voice output in real time from the alarm voice output module 116 and the guide voice output in real time from the ascent rate guide module 118.

The BCD dry suit automatic control module 120 may be configured to determine whether the ascent rate calculated in real time by the ascent rate calculation module 117 is over a predetermined reference.

Further, the BCD dry suit automatic control module 120 may be configured to automatically remotely control the buoyancy of the BCD dry suit 30 so that the ascent rate is maintained under the predetermined reference in accordance with the above determination result. That is, when the ascent rate is too high, it is possible to make a diver stay a current location or dive deeper and stay there by adjusting buoyancy. In detail, the BCD dry suit automatic control module 120 is configured to adjust the amount of air that is supplied to the BCD dry suit 30 from an air tank, and can remotely control opening and closing of a supply valve through wired communication, sound wave communication, or ultrasonic communication.

When divers ascend from deep locations in the water, they ascend usually using the buoyancy of the BCD dry suit 30. The BCD dry suit automatic control module 120 can automatically adjust buoyancy by increasing, maintaining, or decreasing the buoyancy of the BCD dry suit 30 through wired communication, sound wave communication, or ultrasonic communication, and can make a user safely ascend in dependence of automatic control of the BCD dry suit automatic control module 120 for the ascending process itself that may take tens of minutes.

In detail, the BCD dry suit automatic control module 120 may be configured to adjust the amount of air that is supplied to the BCD dry suit 30 from an air tank. The BCD dry suit automatic control module 120 may be configured to increase buoyancy by opening an air injection valve that injects air into the BCD dry suit 30 and to decrease buoyancy by opening an air discharge valve that discharges air from the BCD dry suit 30.

For reference, a diver intake valve that supplies air to an inhalation mask of a diver from an air tank operates separately from the air injection valve or the air discharge valve, and the main valve of the air tank should be always open or adjusted to be partially opened and closed. This is because air should be continuously supplied to a diver through the diver intake valve regardless of opening or closing of the air injection valve or the air discharge valve.

The video camera module 121 may be configured to create video data in real time. The video camera module 123 may be a camera that operates in the water such as Gopro.

The video camera module 123 may be held on a holder 100c of FIG. 4.

The video storage module 122 may be configured such that the video data created in real time by the video camera module 121 are stored.

The video transmission module 123 may be configured to transmit in real time the video data stored in the video storage module 122. The video data can be transmitted to the surface of the water through an ultra-short baseline (USBL) 40.

The eye sensor 124 may be configured to sense in real time whether the eyes of a user are exposed. The eye sensor 124 may be disposed in the XR glasses. The eye sensor 124 can sense that the eyes of a user are not exposed when the user loses consciousness and closes his/her eyes.

The emergency signal transmission module 125 may be configured to generate and transmit an emergency signal when the eyes of a user are not exposed as the real-time sensing result of the eye sensor 124. The emergency signal can be transmitted to the surface of the water through the USBL 40.

The GPS module 126 may be configured to create GPS information in real time.

The GPS module 126 can receive a GPS signal only over the surface of water. When a user ascends to the surface of the water, the GPS module can immediately create GPS location information in real time.

The GPS signal wireless transmission module 127 may be configured to generate in real time a GPS wireless signal including the GPS location information created in real time by the GPS module 126 and to transmit the real-time created GPS wireless signal.

Accordingly, a user ascended to the surface of the water can notify of his/her location.

Meanwhile, the GPS module 126 may be attached to the rear of the XR glasses-equipped underwater exploration helmet 100. Referring to FIG. 3, the GPS module 126 may be attached to the portion where the battery 128 is mounted. When divers lose their consciousness and float up to the surface of the water, their back faces up in most cases. Accordingly, when the GPS module 126 is attached to the rear of the XR glasses-equipped underwater exploration helmet 100, it is possible to smoothly receive a GPS satellite signal without difficulty and transmit a GPS wireless signal too without difficulty.

The GPS signal wireless transmission module 127 may be configured to generate in real time a GPS wireless signal including the GPS location information created in real time by the GPS module 126 and to transmit the real-time created GPS wireless signal.

The battery module 128 may be configured to supply power.

The battery module 128 is, as shown in FIGS. 2 and 3, mounted on the rear of the XR glasses-equipped underwater exploration helmet 100 and can supply power for operating other components. In this configuration, most electronic processing devices 100a excluding the XR display 113, the battery 128, or the sonar module 101 may be attached to the top of the sonar-mounted underwater exploration helmet 100.

Meanwhile, in FIG. 3, an interface module 100b is a component for wired connection with the USBL 30 or the DSMB 20.

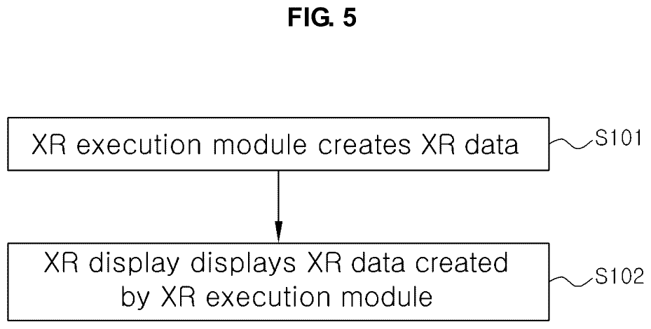

FIG. 5 is a flowchart of a method of operating the XR glasses-equipped underwater exploration helmet according to an embodiment of the present disclosure.

Referring to FIG. 5, the XR execution module 112 creates XR data (S101).

Next, the XR display 113 displays the XR data created by the XR execution module 112 (S102).

In this case, the XR data may be composed of at least one or more of a current water depth, a current underwater temperature, a dive time, and a remaining air volume.

Although the present disclosure was described above with reference to exemplary embodiments, it should be understood that the present disclosure may be changed and modified in various ways by those skilled in the art, without departing from the spirit and scope of the present disclosure described in claims.

1. An XR glasses-equipped underwater exploration helmet comprising:
an XR execution module creating XR data; and
an XR display displaying the XR data created by the XR execution module.

2. The XR glasses-equipped underwater exploration helmet of claim 1, wherein the XR data are composed of at least one or more of a current water depth, a current underwater temperature, a dive time, and a remaining air volume.

3. The XR glasses-equipped underwater exploration helmet of claim 2, further comprising a GPS module creating GPS location information in real time.

4. The XR glasses-equipped underwater exploration helmet of claim 3, further comprising a GPS signal wireless transmission module creating in real time a GPS wireless signal including the GPS location information created in real time by the GPS module, and transmitting the real-time created GPS wireless signal.

5. A method of operating an XR glasses-equipped underwater exploration helmet, the method comprising:
a step in which an XR execution module creates XR data; and
a step in which an XR display displays the XR data created by the XR execution module.

6. The method of claim 5, wherein the XR data are composed of at least one or more of a current water depth, a current underwater temperature, a dive time, and a remaining air volume.
